(19) United States
(12) Patent Application Publication
(10) Pub. No.: US 2012/0036748 A1
(43) Pub. Date: Feb. 16, 2012

(54) DIY LED sign panel arrangement

(76) Inventor: Yu-Chung Yen, Beverly Hills, CA (US)

(21) Appl. No.: 12/806,461

(22) Filed: Aug. 13, 2010

(51) Int. Cl. G09F 13/00

(52) U.S. Cl. 40/541

(57) ABSTRACT

A DIY LED sign panel arrangement for use as an illuminative signboard includes a LED supporting frame which includes a plurality of module holders and a wire arrangement interconnecting the module holders for electrical communications, a power unit for providing power, and a plurality of LED modules. The LED module includes a casing, a LED unit having an illuminating surface for providing illumination, and a module connector on the casing for securing the LED units into position. The LED modules are arranged for forming an adjustable LED module pattern on the LED supporting frame as a text object or a graphical object serving as a sign, such that a user can design his own LED signboard simply by placing the LED modules onto the LED supporting frame as desired.

### BACKGROUND OF THE PRESENT INVENTION

1. Field of Invention

The present invention relates to a sign panel arrangement, and more particularly to a DIY (Do It Yourself) LED sign panel arrangement which allows a user to design and arrange the LED lighting design and effect on the sign panel in a “do it yourself” manner to meet different purposes.

2. Description of Related Arts

The first type of the conventional LED sign panels is customized item which has to be ordered through a manufacture store or the like that involves high level of labor and manufacture cost. The user needs to submit an order and select a design in words or logo which is available and offered from the manufacture store. Most of the time, the availability of various designs is limited but the cost is high.

The second type of the convention LED sign panels is standard sign panel, such as the “OPEN” sign and the restroom sign. There is no design option available and is not possible to modify the panels to suit one's need. For examples, a flower store cannot have an open sign with flower design of its own with this type of standard panels, a bakery cannot have a sign to match her unique decoration and interior design, a stylish restaurant cannot have a restroom sign matching their unique style, and etc.

For small and medium size businesses, the cost of the first type may be too high while the stylish-less second type may not meet their needs. The needs of a designable sign for small and medium size businesses are ignored or there is just no simple and convenience solution available to fit their needs.

Also, non-commercial use of signboard is common in schools, sports club or family. The design of non-commercial signboard is even more challenging because it is difficult to find one solution which is simple and easy for most people while fitting all the needs of different individuals. A designable signboard, which is simple, easy and convenience for average people while providing a great flexibility to fit different needs, is a demand in the market.

### SUMMARY OF THE PRESENT INVENTION

The invention is advantageous in that it provides a flashing and fashionable LED signboard which includes a LED supporting frame and a plurality of LED modules for a user to design his or her own signboard in a convenience way.

Another advantage of the invention is to LED signboard which includes a LED supporting frame, a plurality of LED modules or LED module blocks, and a control module for a user to design his or her own signboard with flashing control in a convenience way.

Another advantage of the invention is to LED signboard which includes a LED supporting frame, a plurality of LED modules or LED module blocks of different color for a user to design his or her own signboard with his or her own mix and match color in a convenience way.

Another advantage of the invention is to LED signboard which includes a frame connector unit for connecting two LED supporting frame such that a signboard of any size is made possible to fit the need of a user.

Additional advantages and features of the invention becomes apparent from the description which follows, and may be realized by means of the instrumentalities and combinations particular point out in the appended claims.

According to the present invention, the foregoing and other objects and advantages are attained by a LED sign panel, comprising:

a LED supporting frame comprising a plurality of module holders provided on a front side of the LED supporting frame and a wire arrangement interconnecting the module holders for electrical communications;

a power unit which is provided on the LED supporting frame for electrically connecting with the wire arrangement and adapted for providing power to the LED supporting frame; and

a plurality of LED modules which are arranged for positioning onto the front side of the LED supporting frame and electrically connect to the LED supporting frame, wherein each of the LED module comprises:

a casing having a front side and a bottom side opposite to the front side;

a LED unit having an illuminating surface extended from the front side of the casing for providing illumination to the front side of the casing; and

a module connector provided on the bottom side of the casing for connecting to one the module holder of the LED supporting frame to secure into position on the LED supporting frame,

wherein the plurality of LED modules are arranged for forming an adjustable LED module pattern on the LED supporting frame and the adjustable LED module pattern is capable of presenting a text object or a graphical object such that the plurality of LED modules is capable of providing a lighting effect for the adjustable LED module pattern.

In accordance with another aspect of the invention, the present invention comprises a DIY LED kits for creating a LED module pattern of a signboard, comprising:

a LED supporting frame comprising a plurality of module holders provided on a front side of the LED supporting frame and a wire arrangement interconnecting the module holders for electrical communications;

a power unit which is provided on the LED supporting frame for electrically connecting with the wire arrangement and adapted for providing power to the LED supporting frame;

a plurality of LED modules which are arranged for positioning onto the front side of the LED supporting frame and electrically connected to the LED supporting frame, wherein each of the LED module comprises: a casing having a front side and a bottom side opposite to the front side, a LED unit having an illuminating surface extended from the front side of the casing for providing illumination to the front side of the casing, and a module connector provided on the bottom side of the casing for connecting to one the module holder of the LED supporting frame to secure into position on the LED supporting frame;

a plurality of LED module blocks which are arranged for positioning onto the front side of the LED supporting frame and electrically connected to the LED supporting frame, wherein each of the LED module comprises: a casing having a front side and a bottom side opposite to the front side, a preset number of LED units, each having an illuminating surface extended from the front side of the casing for providing illumination to the front side of the casing, and a module connector provided on the bottom side of the casing for connecting to one the module holder of the LED supporting frame to secure into position on the LED supporting frame, wherein each of the LED module block has a preset block structure which is constructed as a letter object or a graphical object to form a preset block pattern; and

a control module electrically connected to the LED supporting frame for controlling an on/off status of each of the LED units of the LED modules and the LED module blocks which are electrically connecting to the wire arrangement such that the lighting effect of the LED module pattern which is created through the LED modules and the LED module blocks is controllable under a predetermined sequence through the control module.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is perspective view of a LED signboard according to a preferred embodiment of the present invention.

FIG. 1B is side view of a LED signboard according to the above preferred embodiment of the present invention.

FIG. 2A is a perspective view of a LED module of the LED signboard of according to the above preferred embodiment of the present invention.

FIG. 2B is a cross-sectional view of a LED module of the LED signboard according to the above preferred embodiment of the present invention.

FIG. 3A is a perspective view of an alternative of the LED module according to the above preferred embodiment of the present invention.

FIG. 3B is a cross-sectional view of an alternative of the LED module according to the above preferred embodiment of the present invention.

FIG. 4A to 4E are illustrations for different alternatives of the LED module according to the above preferred embodiment of the present invention.

FIGS. 5A and 5C are illustrations of two alternative wire arrangements of the LED signboard according to the above preferred embodiment of the present invention.

FIG. 5B is an illustration of a wire connector of the LED signboard according to the above preferred embodiment of the present invention.

FIG. 6 is an illustration of connecting two LED supporting frames through a frame connector unit of the LED module according to the above preferred embodiment of the present invention.

FIG. 7 is an illustration of connecting two LED supporting frames through an alternative embodiment of the frame connector unit of the LED module according to the above preferred embodiment of the present invention.

### DETAILED DESCRIPTION OF THE PREFERRED EMBODIMENT

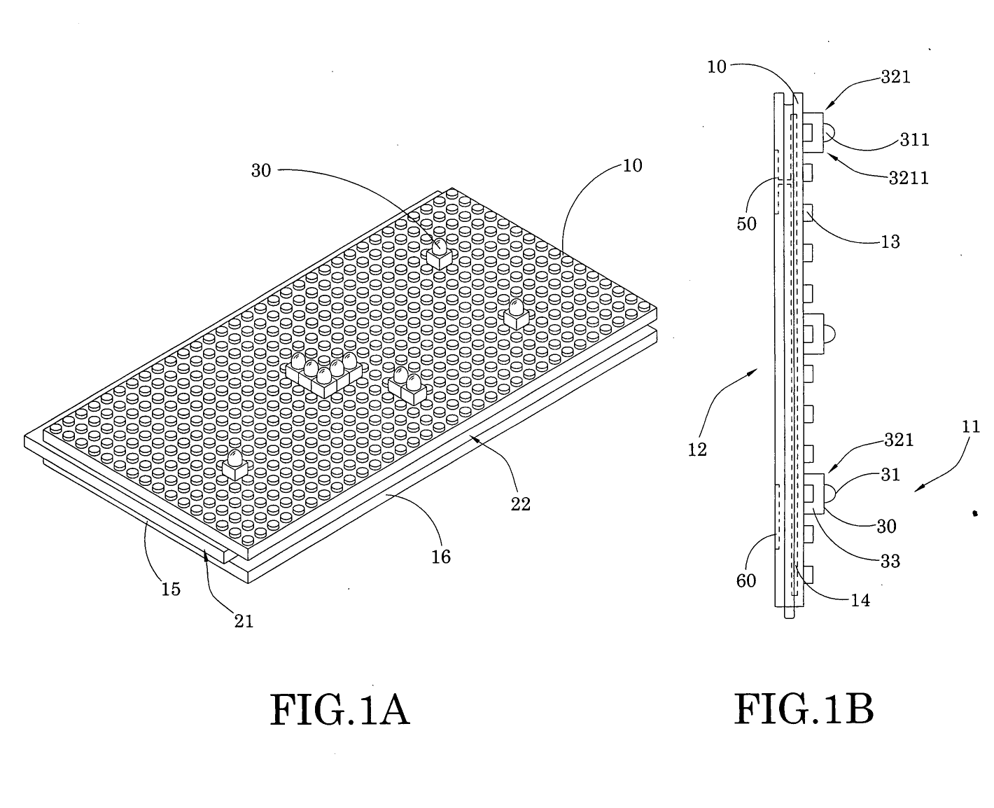

Referring to FIGS. 1A and 1B of the drawings, a LED sign panel arrangement, which is constructed as a signboard, according to a preferred embodiment of the present invention includes a LED supporting frame 10, a power unit 60, a plurality of LED modules 30, and a control module 50.

The LED supporting frame 10 is provided as a design board for a user to create his own signboard such that the user can make use of the LED modules 30 to position onto the LED supporting frame 10 to design and create the signboard.

The LED supporting frame 10 has a front side 11 and a back side 12 and includes a plurality of module holders 13 provided on the front side 11 of the LED supporting frame 10 and a wire arrangement 14 interconnecting between the module holders 13 for electrical communications.

Preferably, the LED supporting frame 10 has a quadrangular construction and the module holders 13 are evenly and systematically arranged along two perpendicular axes of the LED supporting frame so as to facilitate the formation of a two-dimensional pattern on the LED supporting frame.

The power unit 60 is provided on the LED supporting frame 10 for electrically connecting with the wire arrangement 14 and adapted for providing power to the LED supporting frame 10. The power unit 60 can be a power inlet for connecting to a power source or a replaceable and/or rechargeable power source positioned within the LED supporting frame 10. Preferably, the power unit 60 is positioned at the back side 12 of the LED supporting frame 10 and is invisible from the front side 11 of the LED supporting frame 10.

The LED modules 30 are arranged for positioning onto the front side 11 of the LED supporting frame 10 and electrically connected to the LED supporting frame 10. The LED modules 30 are identical in structure, each of the LED module 30 includes a casing 32, a LED unit 31, and a module connector 33.

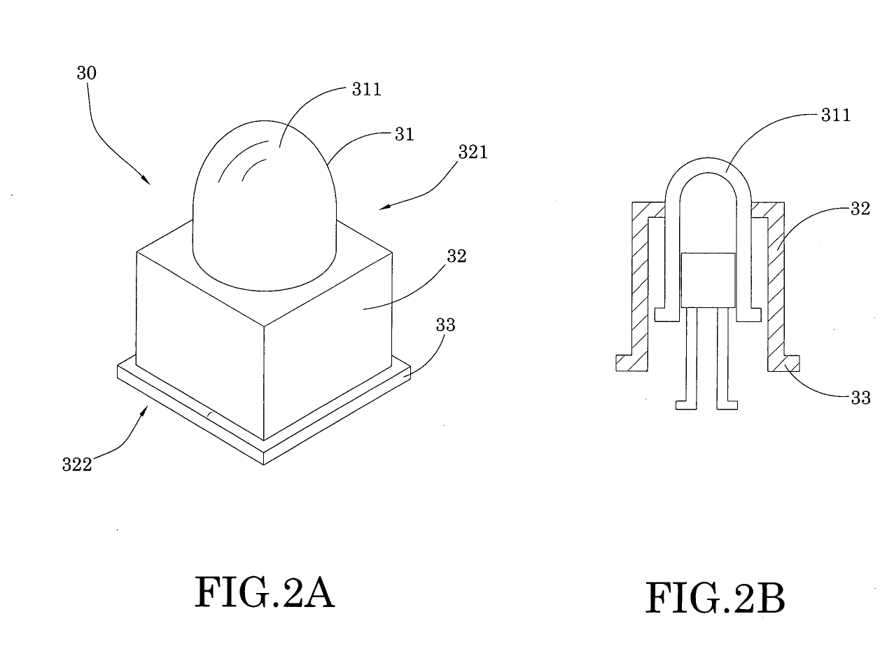

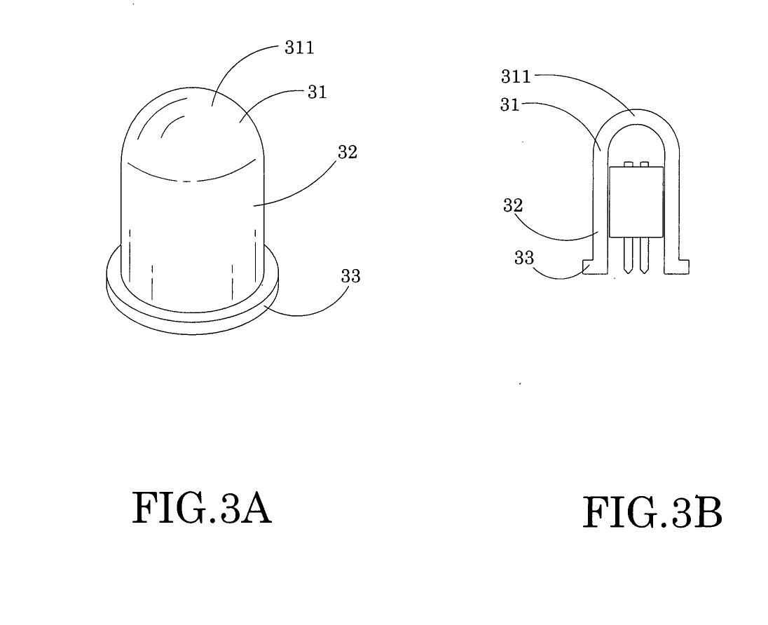

Referring to FIGS. 2A-B and 3A-B of the drawings, the casing 32 has a front side 321 and a bottom side 322 opposite to the front side 321. The LED unit 31 has an illuminating surface 311 extended from the front side 321 of the casing 32 for providing illumination to the front side 321 of the casing 32. The module connector 33 is provided on the bottom side 322 of the casing 32 for connecting to one of the module holder 13 of the LED supporting frame 10 to secure the LED module 30 into position on the LED supporting frame 10.

Accordingly, referring to FIGS. 1A and 1B of the drawings, the plurality of LED modules 13 are arranged for forming an adjustable LED module pattern on the LED supporting frame 10 and the adjustable LED module pattern is capable of presenting a text object or a graphical object such that the plurality of LED modules 13 are capable of providing a lighting effect for the adjustable LED module pattern. For examples, the module pattern can be a word, a symbol, a two-dimensional graphic design or a slogan. The user is free to use the signboard to design and create a LED signboard of any form or for any purposes. Accordingly, the signboard provides great flexibilities to the user and can be used for indoor decoration and advertisement, as a company name sign or an address sign, a close/open sign, a promotion sign, a logo and etc in any languages and words, for any kind of shops such as restaurants, gift shop, office, etc., or for any occasions such as concerts and sports events or any other events.

Referring to FIG. 1B of the drawings, the control module 50 is electrically connected to the wire arrangement 14 of the LED supporting frame 10 for controlling an on/off status of each of the LED unit 31 when the LED unit 31 is electrically connected to the wire arrangement 14 and is powered through the power unit 60. Therefore, the lighting effect of the adjustable LED module pattern is controllable under a predetermined sequence through the control module. In other words, the control module 50 is capable of providing flashing and flashing in a predetermined manner or sequence to the LED units 31 connected on the LED supporting frame 10. Accordingly, the signboard of the present invention can have a specific flashing effect.

Preferably, the front side 321 of the casing 32 further defines an exposing surface 3211 having a color which is the same as a color of the front side 11 of the LED supporting frame 10. Accordingly, when the LED modules 30 which are connected to the LED supporting frame 10 are viewed together with the LED supporting frame 10, the non-illuminating portion, which are the portion of the LED supporting frame 10 without any LED module 30 connected thereon and the exposing surface 3211 of the LED modules 30 connected thereon, is of one color and is viewed as one continuous surface, while the LED module pattern with lighting or flashing effect through the illuminating surface 311 of the LED unit 31 is prominently displayed on the one continuous surface.

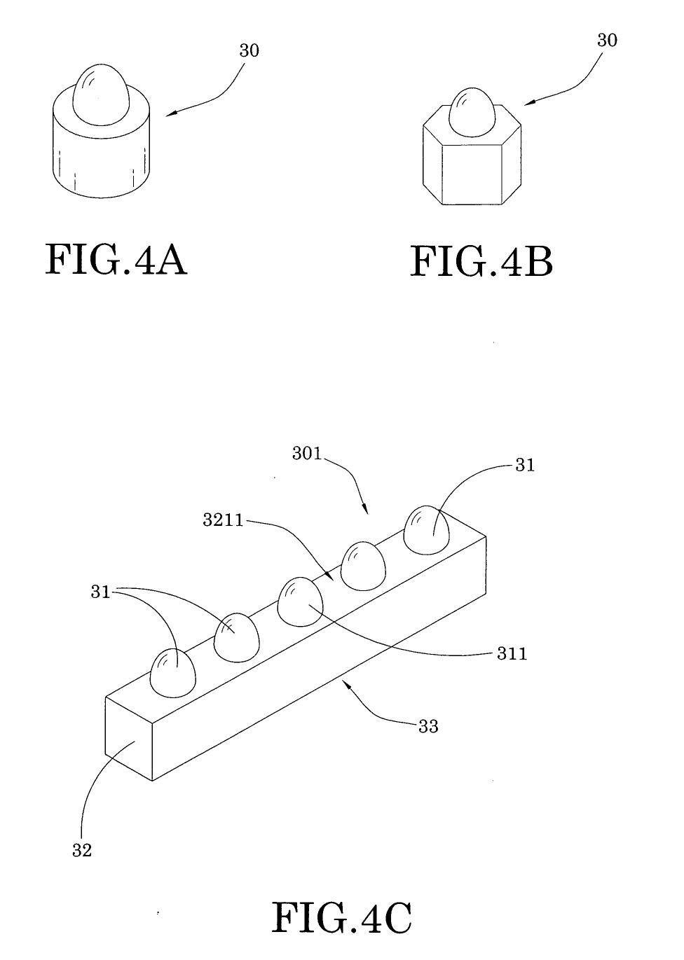

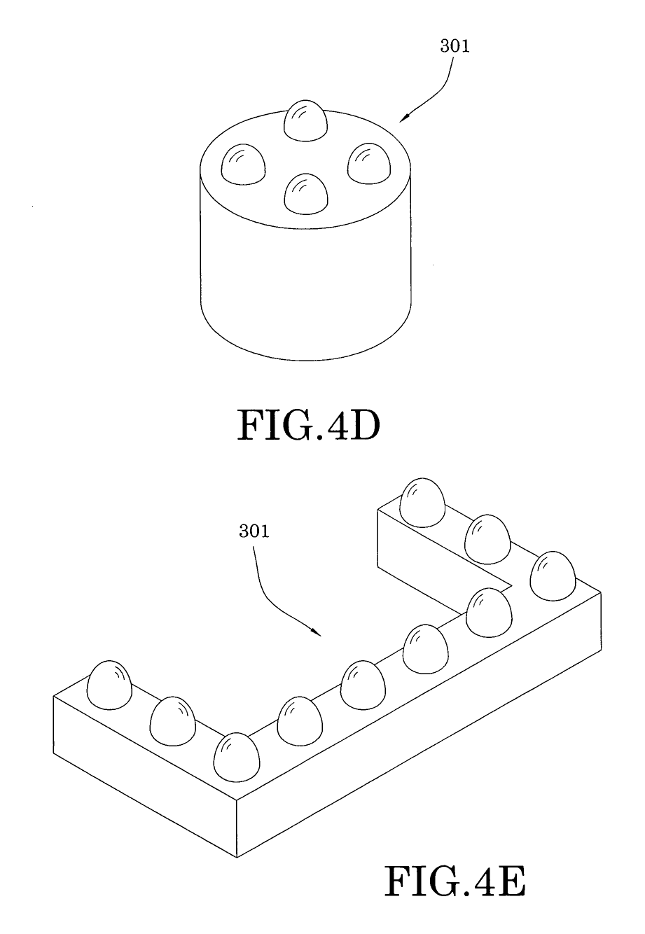

Referring to FIGS. 4A and 4B of the drawings, the LED module 30 can be constructed into different structure, such as a cylindrical block as shown in FIG. 4A and a hexagonal block as shown in FIG. 4B. Therefore, the user is provided with a plurality of choices to mix and match the LED modules 30 of different construction to design the signboard.

Referring to FIGS. 4C to 4D of the drawings, the LED sign panel arrangement, according to a preferred embodiment of the present invention further includes a plurality of LED module blocks 301 of different construction, wherein each of the LED module blocks 301 comprises a casing 32, a preset number of LED units 31 and a module connector 33. The casing 32 has a front side 321 and a bottom side 322 opposite to the front side 321. The LED unit 31 has an illuminating surface 311 extended from the front side 321 of the casing for providing illumination to the front side 321 of the casing 32. The module connector 33 is provided on the bottom side 322 of the casing 32 for connecting to a preset number of the module holders corresponding to the preset number of the LED units 31 to secure the LED module block onto the LED supporting frame into position.

The LED module block 301 has a preset block structure which is constructed as a letter object or a graphical object to form a preset block pattern such that each of the LED module blocks 301 is capable of providing a lighting effect showing the block pattern on the LED supporting frame. For examples, the LED module block 301 can be constructed as a letter “I”, as shown in FIG. 4C, a symbol representing ‘period’ as shown in FIG. 4D, or a graphical structure as shown in FIG. 4E. In other words, the LED module blocks 301 of different constructions are provided as some templates to ease the job of the user.

Similarly, the LED module block 301 is arranged for positioning onto the front side 11 of the LED supporting frame 12 and electrically connected to the LED supporting frame 11, and an on/off status of each of the LED units electrically connecting to the wire arrangement is controlled through the control unit 50 such that the lighting effect of the LED module blocks 301, which is defined as a block pattern, is controllable under a predetermined sequence through the control module.

Preferably and similarly, the front side 321 of the casing 32 of the LED module block further defines an exposing surface 3211 having a color which is the same as a color of the front side 11 of the LED supporting frame 10. Accordingly, when the LED module blocks 30 and the LED modules 30, which are connected to the LED supporting frame 10, are viewed together with the LED supporting frame 10, the non-illuminating portion, which are the portion of the LED supporting frame 10 without any LED module 30 or module block 301 connected thereon and the exposing surface 3211 of the LED modules 30 and module blocks 301 connected thereon, is of one color and is viewed as one continuous surface, while the LED module pattern and the block pattern with lighting or flashing effect through the illuminating surfaces 311 of the LED units 31 are prominently displayed on the one continuous surface. In other words, a two-layered display is formed, irregardless a height of the LED module 30 or the module block 301.

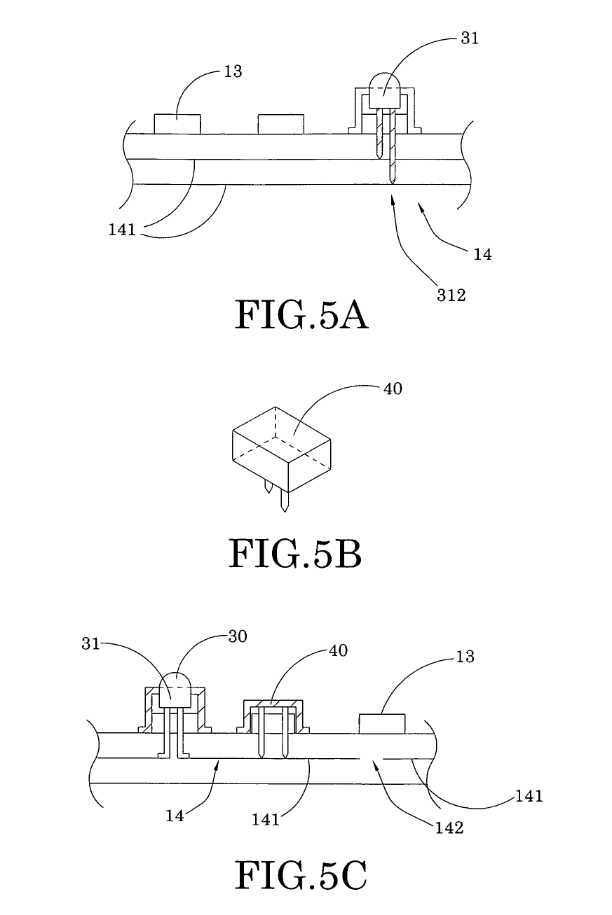

Referring to FIGS. 5A and 5C of the drawings, the wire arrangement 14 comprises a plurality of connecting wires 141 interconnected electrically to the power unit 60 and to provide electrical communications for each of the module holders 13 such that each of the LED units 31 is capable of positioning on the corresponding module holder 13 and connecting to the power source through the connecting wires 141 provided on the module holder 13. In particular, the LED unit 31 has two terminals 312 extended towards the bottom side 322 of the casing 32, adapted for electrically connecting to the connecting wires 141 of the wire arrangement 14.

Referring to FIG. 5A of the drawings, the connecting wires 141 are interconnected electrically behind the front side 11 of the LED supporting frame 10, and the LED unit 31 can be electrically connected through the interconnected connecting wires 141 when each of the two terminals 312 is in physical contact to the correct terminal at any position. Preferably, each of the two terminals 312 of one LED unit 31 is a pointed end such that the two terminals 312 can be pinned to penetrate through the front side 11 of the LED supporting frame 10 to connect to the wire arrangement 14 which is behind the front side 11 of the LED supporting frame 10. It is worth mentioning that the front side 11 of the LED supporting frame 10 is an intact surface which has a matching color with respect to the LED modules for forming the one continuous background for the signboard.

Referring to FIGS. 5B and 5C of the drawings, the plurality of connecting wires 141 defines a connecting gap 142 for each of the module holder 13 and the wire arrangement 14 further comprises a plurality of wire connectors 40 for providing electrical connection through the connecting gap between two adjacently positioned connecting wires without providing any illumination. When one LED unit 31 is positioned on the LED supporting frame 10 through the connection between the module holder 13 and the module connector 33, the two terminals 312 are fitted to fill the connecting gap 142 to connect to the two adjacently positioned connecting wires 141 respectively such that electrical connection is established and enabled. In other words, the circuit on the LED supporting frame can be completed through the LED modules 30 and the wire connectors 40. In other words, when the LED unit 31 is arranged on the LED supporting frame 10 to provide the lighting effect of the LED module pattern, missing gaps of electrical connection to the power unit, which is the disconnected ends of the module holders, is completed through the wire connectors 40.

It is worth mentioning that the wire connector 40 is preferably to have a color which is the same as the color of the front side 11 of the LED supporting frame 10. Accordingly, when the wire connectors 40, which are connected to the LED supporting frame 10, are viewed together with the LED supporting frame 10, the wire connectors 40 are viewed as one continuous surface as the LED supporting frame 10 such that the LED module pattern with lighting or flashing effect through the illuminating surface 311 of the LED unit 31 can be prominently displayed on the one continuous surface, irregardless the height discrepancies between the wire connectors 40 and the LED supporting frame 10, or between the wire connectors 40 and the exposing surface of the casing 32 of the LED module 30.

Referring to FIG. 5C of the drawings, alternatively, each of the two terminals 312 of one LED unit 31 and each of the two terminals of one wire connector 40 can have a flattened end. In this case, predrilled holes on the front side 11 of the LED supporting frame 10 are provided to facilitate the connection.

It is worth mentioning that the construction of the two terminals of each LED unit of the LED module block is the same as that of the LED module.

Referring to FIGS. 1A, 6 and 7 of the drawings, the LED sign panel arrangement further comprises a frame connector unit 20 provided on at least one side of the LED supporting frame 10 which is adapted for interconnecting two LED supporting frames to form one unit. The frame connector unit 20 comprises a first connector member 21 and a second connector member 22 which can be integrally formed on the LED supporting frame 10 or is detachably connected to the LED supporting frame 10.

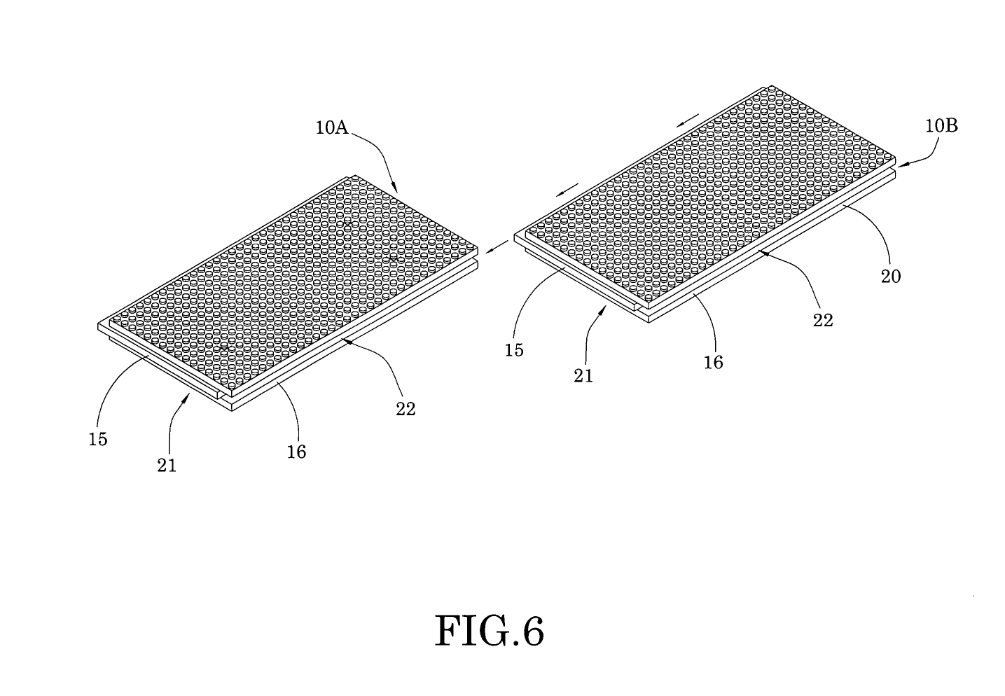

Referring to FIG. 6 of the drawings, the frame connector unit 20 is integrally formed along two connecting edges 15, 16 of the LED supporting frame 10, wherein the first connector member 21 is provided on the first connecting edge 15 and the second connector member 22 is provided on the second connecting edge 16. In particular, the frame connector unit 20 is a tongue and groove arrangement, wherein the first connector member 21 is a protruded member and the second connector 22 is an indention groove. Accordingly, the protruded member 21 of a first LED supporting frame 10A can be sliding into the indention groove 22 of a second LED supporting frame 10B to form one unit. It is worth mentioning that the positions of the first and second connectors can be reversed in which the protruded member 21 is positioned at the second edge 16 and the indention groove is provided at the first edge 15.

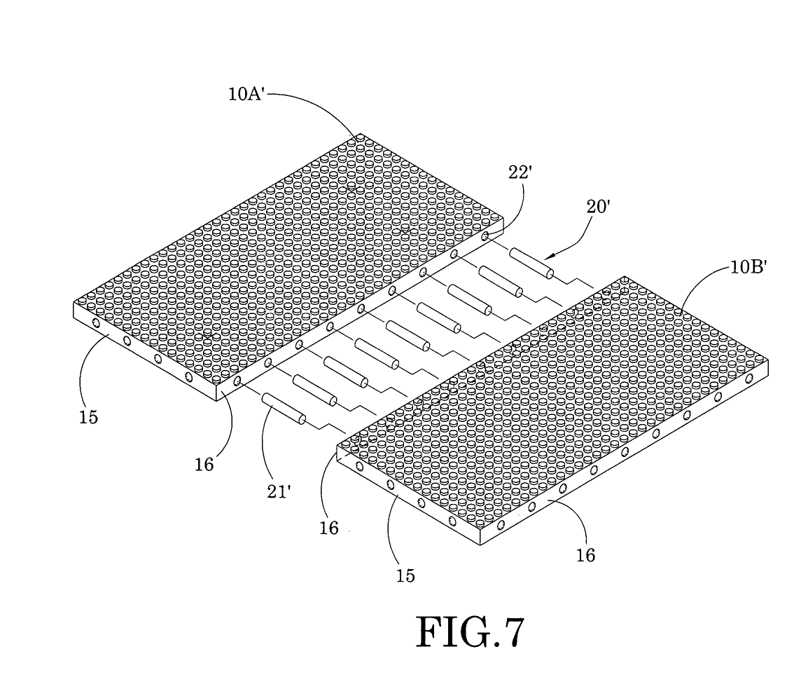

Alternately, the frame connector unit 20 is a coupling arrangement 20′ in which the first connector 21 is a shaft member 21 and the second connector 22 is coupling hole 22′ provided on the edge portion of the LED supporting frame 10. In other words, as shown in FIG. 7 of the drawings, the first LED supporting frame 10A′ is connected to the second LED supporting frame 10B′ to form one unit through insertion of the shaft member 21′ to the coupling hole 22′. It is noted that other alternative settings for the frame connector unit 20 can also be used for the present invention.

It is worth mentioning that in the application of the present invention, the LED supporting frames 10, the LED modules 30, the LED module blocks 301 and/or the wire connectors 40 will be provided in different colors so that the user is free to design his or her own signboard. In other words, the present invention also provides a LED signboard kits for creating a LED module pattern of a signboard which includes a LED supporting frame 10, a power unit 60, a plurality of LED modules 30, a plurality of module blocks 301 and a control module 50. The description of the supporting frame 10, the power unit 60, the LED modules 30, the module blocks 301 and the control module 50 are the same as the description as mentioned above. The DIY LED signboard kits can offer a convenience solution to meet different needs of different personal or commercial use. The user can design his own LED module pattern and has a unique LED signboard belonging to him only.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED signboard, comprising:
a LED supporting frame comprising a plurality of module holders provided on a front side of said LED supporting frame and a wire arrangement interconnecting said module holders for electrical communications;
a power unit provided on said LED supporting frame for electrically connecting with said wire arrangement, adapted for providing power to said LED supporting frame; and
a plurality of LED modules which are arranged for positioning onto said front side of said LED supporting frame and electrically connected to said LED supporting frame, wherein each of said LED modules comprises:
a casing having a front side and a bottom side opposite to said front side;
a LED unit having an illuminating surface extended from said front side of said casing for providing illumination to said front side of said casing; and
a module connector provided on said bottom side of said casing for connecting to one said module holder of said LED supporting frame to secure into position on said LED supporting frame,
wherein said plurality of LED modules are arranged for forming an adjustable LED module pattern on said LED supporting frame and said adjustable LED module pattern is capable of presenting a text object or a graphical object such that said plurality of LED modules are capable of providing a lighting effect for said adjustable LED module pattern.

2. The LED signboard, as recited in claim 1, further comprising a control module electrically connected to said wire arrangement of said LED supporting frame for controlling an on/off status of each of said LED unit electrically connecting to said wire arrangement such that said lighting effect of said adjustable LED module pattern is controllable under a predetermined sequence through said control module.

3. The LED signboard, as recited in claim 2; wherein a color of said front surface of said casing is the same as a color of said LED supporting frame.

4. The LED signboard, as recited in claim 1, further comprising at least one LED module block which is arranged for positioning onto said front side of said LED supporting frame and electrically connected to said LED supporting frame, wherein each of said LED module block comprises:
a casing having a front side and a bottom side opposite to said front side;
a preset number of LED units, each having an illuminating surface extended from said front side of said casing for providing illumination to said front side of said casing; and
a module connector provided on said bottom side of said casing for connecting to one said module holder of said LED supporting frame to secure into position on said LED supporting frame,
wherein each of said LED module block has a preset block structure which is constructed as a letter object or a graphical object to form a preset block pattern such that each of said LED module block is capable of providing a lighting effect showing said block pattern on said LED supporting frame.

5. The LED signboard, as recited in claim 4, further comprising a control module electrically connected to said LED supporting frame for controlling an on/off status of each of said LED units electrically connecting to said wire arrangement such that the lighting effect of said LED module pattern and said block pattern is controllable under a predetermined sequence through said control module.

6. The LED signboard, as recited in claim 5, wherein a color of said front surface of said casing of said LED module is the same as a color of said LED supporting frame, wherein a color of said front surface of said casing of said LED module block is the same as a color of said LED supporting frame.

7. The LED signboard, as recited in claim 1, wherein said wire arrangement comprises a plurality of connecting wires interconnected electrically to said power unit and to provide electrical communications for each of said module holders such that each of said LED units is capable of positioning on said corresponding module holder and connecting to said power source through said connecting wires provided on said module holder.

8. The LED signboard, as recited in claim 3, wherein said wire arrangement comprises a plurality of connecting wires interconnected electrically to said power unit and to provide electrical communications for each of said module holders such that each of said LED units is capable of positioning on said corresponding module holder and connecting to said power source through said connecting wires provided on said module holder.

9. The LED signboard, as recited in claim 5, wherein said wire arrangement comprises a plurality of connecting wires interconnected electrically to said power unit and to provide electrical communications for each of said module holders such that each of said LED units is capable of positioning on said corresponding module holder and connecting to said power source through said connecting wires provided on said module holder.

10. The LED signboard, as recited in claim 8, wherein said LED supporting frame has a quadrangular construction and said module holders are evenly and systematically arranged along two perpendicular axes of said LED supporting frame so as to facilitate the formation of a two-dimensional pattern on said LED supporting frame.

11. The LED signboard, as recited in claim 9, wherein said LED supporting frame has a quadrangular construction and said module holders are evenly and systematically arranged along two perpendicular axes of said LED supporting frame so as to facilitate the formation of a two-dimensional pattern on said LED supporting frame.

12. The LED signboard, as recited in claim 10, further comprising a frame connector unit provided on at least one side of said LED supporting frame, adapted for connecting two said LED supporting frames to form one unit.

13. The LED signboard, as recited in claim 11, further comprising a frame connector unit provided on at least one side of said LED supporting frame, adapted for connecting two said LED supporting frames to form one unit.

14. The LED signboard, as recited in claim 1, wherein said wire arrangement comprises a plurality of connecting wires to define a connecting gap for each of said module holder, wherein each of said LED units is electrical connecting to two said adjacently positioned connecting wires between said corresponding connecting gap, wherein said wire arrangement further comprises a plurality of wire connectors for providing electrical connection through said connecting gap between two said adjacently positioned corresponding connecting wires without any illumination, wherein each of said wire connector has a color which is the same as a color of said front side of said LED supporting frame, wherein when said LED unit is arranged on said LED supporting frame to provide the lighting effect of the LED module pattern, missing gaps of electrical connection to said power unit is completed through said wire connectors.

15. The LED signboard, as recited in claim 3, wherein said wire arrangement comprises a plurality of connecting wires to define a connecting gap for each of said module holder, wherein each of said LED units is electrical connecting to two said adjacently positioned connecting wires between said corresponding connecting gap, wherein said wire arrangement further comprises a plurality of wire connectors for providing electrical connection through said connecting gap between two said adjacently positioned corresponding connecting wires without any illumination, wherein each of said wire connector has a color which is the same as said color of said front side of said LED supporting frame, wherein when said LED unit is arranged on said LED supporting frame to provide the lighting effect of said LED module pattern, missing gaps of electrical connection to said power unit is completed through said wire connectors.

16. The LED signboard, as recited in claim 6, wherein said wire arrangement comprises a plurality of connecting wires to define a connecting gap for each of said module holder, wherein each of said LED units is electrical connecting to two said adjacently positioned connecting wires between said corresponding connecting gap, wherein said wire arrangement further comprises a plurality of wire connectors for providing electrical connection through said connecting gap between two said adjacently positioned corresponding connecting wires without any illumination, wherein each of said wire connector has a color which is the same as said color of said front side of said LED supporting frame, wherein when said LED unit is arranged on said LED supporting frame to provide the lighting effect of said LED module pattern formed by said LED modules and said LED module blocks, missing gaps of electrical connection to said power unit is completed through said wire connectors.

17. The LED signboard, as recited in claim 14, wherein said LED supporting frame has a quadrangular construction and said module holders are evenly and systematically arranged along two perpendicular axes of said LED supporting frame so as to facilitate the formation of a two-dimensional pattern on said LED supporting frame.

18. The LED signboard, as recited in claim 15, wherein said LED supporting frame has a quadrangular construction and said module holders are evenly and systematically arranged along two perpendicular axes of said LED supporting frame so as to facilitate the formation of a two-dimensional pattern on said LED supporting frame.

19. The LED signboard, as recited in claim 17, further comprising a frame connector unit provided on at least one side of said LED supporting frame, adapted for connecting two said LED supporting frames to form one unit.

20. The LED signboard, as recited in claim 18, further comprising a frame connector unit provided on at least one side of said LED supporting frame, adapted for connecting two said LED supporting frames to form one unit.

21. A LED signboard kits for creating a LED module pattern of a signboard, comprising:
a LED supporting frame comprising a plurality of module holders provided on a front side of said LED supporting frame and a wire arrangement interconnecting said module holders for electrical communications;
a power unit provided on said LED supporting frame for electrically connecting with said wire arrangement, adapted for providing power to said LED supporting frame;
a plurality of LED modules which are arranged for positioning onto said front side of said LED supporting frame and electrically connected to said LED supporting frame, wherein each of said LED modules comprises: a casing having a front side and a bottom side opposite to said front side, a LED unit having an illuminating surface extended from said front side of said casing for providing illumination to said front side of said casing; and a module connector provided on said bottom side of said casing for connecting to one said module holder of said LED supporting frame to secure into position on said LED supporting frame;
a plurality of LED module blocks which are arranged for positioning onto said front side of said LED supporting frame and electrically connected to said LED supporting frame, wherein each of said LED modules comprises: a casing having a front side and a bottom side opposite to said front side, a preset number of LED units, each having an illuminating surface extended from said front side of said casing for providing illumination to said front side of said casing, and a module connector provided on said bottom side of said casing for connecting to one said module holder of said LED supporting frame to secure into position on said LED supporting frame, wherein each of said LED module block has a preset block structure which is constructed as a letter object or a graphical object to form a preset block pattern; and
a control module electrically connected to said LED supporting frame for controlling an on/off status of each of said LED units of said LED modules and said LED module blocks which are electrically connecting to said wire arrangement such that the lighting effect of said LED module pattern which is created through said LED modules and said LED module blocks is controllable under a predetermined sequence through said control module.

22. The LED signboard kits, as recited in claim 21, wherein a color of said front surface of said casing of said LED module is the same as a color of said LED supporting frame, wherein a color of said front surface of said casing of said LED module block is the same as a color of said LED supporting frame.

23. The LED signboard kits, as recited in claim 22, wherein said wire arrangement comprises a plurality of connecting wires interconnected electrically to said power unit and to provide electrical communications for each of said module holders such that each of said LED unit is capable of positioning on said corresponding module holder and connecting to said power source through said connecting wires provided on said module holder.

24. The LED signboard kits, as recited in claim 23, wherein said LED supporting frame has a quadrangular construction and said module holders are evenly and systematically arranged along two perpendicular axes of said LED supporting frame so as to facilitate the formation of a two-dimensional pattern on said LED supporting frame.

25. The LED signboard kits, as recited in claim 24, further comprising a frame connector unit provided on at least one side of said LED supporting frame, adapted for connecting two said LED supporting frames to form one unit.
